(19) United States
(12) Patent Application Publication
(10) Pub. No.: US 2026/0364715 A1
(43) Pub. Date: Nov. 19, 2026

(54) LASER CUTTING MACHINE AND METHOD OF CONTINUOUS CUTTING OF SHEET METAL AND SEGREGATION OF WORKPIECES AND WASTE IN A LASER CUTTING MACHINE

(71) Applicant: EAGLE POWER JANUSZ MARCIN EJMA, Walcz (PL)

(72) Inventor: Janusz Marcin EJMA, Walcz (PL)

(21) Appl. No.: 19/132,565

(22) PCT Filed: Nov. 17, 2023
(86) PCT No.: PCT/PL2023/050095

§ 371 Date: May 23, 2025

(30) Foreign Application Priority Data
Nov. 25, 2022 (PL) P.442946

(51) Int. Cl. B23K 26/08; B23K 26/16; B23K 26/38; B23K 101/18

(52) U.S. Cl. CPC B23K 26/0846; B23K 26/16; B23K 26/38; B23K 2101/18

(57) ABSTRACT

A cutting machine includes a loading conveyor and an internal conveyor moving linearly in the direction of the X axis with rotating load-bearing elements, with a slot located between them, a head unit with a control system that moves over sheet metal in a slot area (C) dynamically in X, Y, Z axes, according to the set software. At least one side gripper is slidably mounted on at least one side of the body, and the internal conveyor is detachably connected to the unloading conveyor, which is a separate module connected directly to the internal conveyor and moves linearly in both sides along the X direction thanks to the linear drive of the internal conveyor. In the working area under the loading conveyor and the internal conveyor there is an extraction unit.

### FIELD

The object of the invention is a laser cutting machine for cutting sheet metal, especially unrolled from coils or fed automatically in sheets, and a method of continuous laser cutting of sheet metal and segregation of waste and workpieces in this cutting machine.

### BACKGROUND

Known laser cutters are structures that have elements and units that allow the loading of material and its movement toward the cutting area, elements and parts that enable the cutting process, and after the cutting is completed, that allow the collection of workpieces and waste. The basic working element in the cutting area of the cutter is the cutting head. It basically consists of a nozzle, a lens and a focus tracking system. The cutting head of the laser cutting machine moves along the programmed cutting path, with precision and speed being among the basic parameters of the cutting machine. Laser power has a major impact on cut thickness, cut speed, cut width and cut quality. In general, the higher the laser power, the greater the cutting depth and the higher the cutting speed. The cutting head is suspended from gates/traverses. The gate unit with the cutting head and control system moves over the surface of the cut material placed on tables/conveyors, on which sheet metal unrolled from a coil or fed automatically in sheets is placed. The cutting head moves in the X and Y directions, but solutions are known in which it is possible to move the cutting head also in the Z direction, where the X axis of the cutting machine is defined along the longest side from the entrance of the material to the exit of the finished product, the Y axis of the cutting machine is defined along the short side of the machine, and the Z axis of the cutting machine is defined as the height of the machine from the base to the roof of the machine. The Z axis makes it possible to adjust the height/thickness of the sheet metal to be processed.

The basic element of the device in the loading and feeding area of the cutting material are the cutting tables, onto which the material is loaded. The smaller tables are cast in iron or aluminum and are stationary structures supporting the material being processed during cutting. They do not have any additional rotating modules. After the cutting process, the workpieces and waste are collected by the operator or by additional equipment such as robots. In large cutting machines, the tables are conveyors mounted in the body guides.

Known laser cutting machines are equipped with an operator's station for conducting, monitoring and controlling the entire process, as well as basic peripheral modules to ensure the operation of the equipment, namely: laser radiation sources, laser source coolers and cutting chamber de-dusting devices. In addition, the devices are equipped with a laser beam transmission system, through which the light beam generated in the source is transmitted to the cutting head via a fiber optic system.

The equipment also uses CNC systems that control the operation of all modules and components, such as loading and unloading systems, laser output control and cutting head feed control along the X, Y and Z axes, as well as sheet alignment systems, systems for automatic loading and unloading of sheet metal, both unrolled from a coil and automatically fed in sheets, and systems for automatic unloading of finished workpieces and waste.

In addition, the cutting machines use cooling systems for the laser generator, which converts electrical energy into light energy, and where the remaining energy is converted into heat, dissipates excess heat and ensures even laser operation and stable operation of the beam transmission system, prevents deformation and cracking of the lens caused by excessive temperature. Known cutters use air or water cooling systems. During the cutting process, fumes and dust are generated, which can affect not only the quality of the cutting process, but also the health of operators. Therefore, automatic fume and dust removal systems are installed in the cutting machines.

Known cutters are mostly complex structures.

There is an EAGLE laser cutting device which contains two tables placed on metal sheets formed inside the body in the form of cams, where the rollers move on the cams. The openwork load-bearing platform of the tables, on which the metal sheets are placed, is formed by metal combs. The sheet metal rests against the ends of the combs and the tables move toward the cutting area, where there is a gate unit with a cutting head that moves in a sliding motion in X, Y, Z directions. The basic elements responsible for the system's feed, including the movement of the platforms supporting the tables, are motors such as stepper motors or servo motors and chains attached to the tables. The tables switch their positions alternately but always along the same path, which means that table one lifts and table two slides under table one horizontally. Table two becomes table one after swapping, and vice versa. The cutting method in this cutting machine is based on two tables that change their position by passing one above the other. A full sheet of metal is loaded onto the first table on the combs. At this time, the second table is already in the machine. The tables are stationary during cutting. Above the second table the cutting process takes place where the cutting head moves in the X, Y, Z axes, and the sheet metal with the table does not move. When cutting sheet metal on table one, the process of unloading the finished cut workpieces and then loading a new sheet occurs. Table replacement involves the tables passing each other in the middle of their path, where table one lifts on a cam and table two horizontally slides under table one. After a full movement, table one returns to the horizontal position. The unloading or loading process can be manual or automatic depending on the type of machine. In the described known device, cutting is carried out over fixed table elements in the form of metal combs, which undergo unintentional undercutting during the process, and metal shards accumulate between the combs. In addition, it is possible to weld the ends of the combs to the sheet metal, as well as to change the properties of the sheet metal in the area of contact with the combs. The cutting process requires stopping sheet feeding processes and only applies to cutting single sheets.

A device for laser cutting of sheet metal unrolled from a coil is known from the Polish patent description PL227075B1. The device includes a table on which a web of sheet metal unrolled from a coil moves in a continuous motion, a gate unit equipped with a laser cutting head, and a control system, with the gate unit with the cutting head being moved in a sliding manner over the table surface in two perpendicular axes of the X and Y table planes, with the table containing a series of support rollers, embedded in the table guide, arranged perpendicular to the direction of sheet metal transport at fixed distances, not larger than the diameter of a single support roller. The support rollers are arranged in such a way that they can freely rotate around their own axis, and there is a tracking table equipped with a slot in the table between the support rollers for discharging the laser-treated material, while the movement of the tracking table along the axis in line with the movement of the sheet metal is integrated with the movement of the gate unit. The essential features of the invention in the device category are that the support rollers are slidably fixed and moved in a table guide along an axis in line with the direction of sheet transport, with the support rollers connected to each other by flexible connectors. In an advantageous implementation of the invention, the support rollers have a drive, advantageously an electric one, controlled from the control system, the said drive providing the support rollers with a rotational speed corresponding to the linear speed of the sheet web travel. In another advantageous implementation of the invention, the flexible connectors are tie rods, chains, cables or strings. In a further advantageous implementation of the invention, the support rollers are made of heat-resistant material, advantageously steel. In an even more advantageous implementation of the invention, the slot in the tracking table has an adjustable width. In this device, there is a single table on which a web of sheet metal unrolled from a coil moves. The load-bearing platform of the table is formed by rotating rollers mounted in the table guide perpendicular to the direction of sheet travel, and between the rollers there is a slot called a tracking table for discharging the laser-treated material, and the movement of the tracking table along the axis in line with the movement of the sheet metal is integrated with the movement of the gate unit, so that the support rollers are moved in a sliding manner in the table guide along the axis in line with the direction of sheet metal transport.

A method for laser cutting of metal sheets unrolled from a coil, which includes the following stages, is also known from the Polish invention description PL227075B1:
a) a web of sheet metal is placed on the table,
b) a sheet metal web is moved in a continuous motion along the surface of the table, which is a series of bearing-mounted support rollers, arranged perpendicular to the direction of sheet metal transport at fixed intervals, not larger than the diameter of a single support roller,
c) a gate unit equipped with a laser cutting head moves over the table surface,
d) a tracking table moves, equipped with a slot for discharging the laser-treated material, arranged between support rollers,
e) the desired pattern, set by the control system, is cut out with a laser beam emitted from the laser cutting head, with steps (b), (c), (d) and (e) being carried out simultaneously, and the movement of the tracking table along the axis in line with the movement of the sheet is integrated with the movement of the gate unit.

The essential features of the method are that the support rollers embedded in the table guide, connected by flexible connectors, are moved in a sliding manner along the axis in line with the direction of sheet transport, and the gate unit is moved over the entire table surface. In an advantageous implementation of the invention, the support rollers have a drive, advantageously an electric one, controlled from the control system, the said drive providing the support rollers with a rotational speed corresponding to the linear speed of the sheet web travel. In another advantageous implementation of the invention, the flexible connectors are tie rods, chains, cables or strings. In another advantageous implementation of the invention, the slot in the tracking table has an adjustable width.

A method of laser cutting of preset parts and a device implementing this method are known from the description of international patent application No. WO 2012034 923A. The device consists of a table over which a gate moves in a sliding manner, on which the laser cutting head is placed. The design of the gate allows the laser cutting head to move in two axes, making it possible to perform laser cutting of any two-dimensional shape, limited by the range of movement of the gate. The working element to be cut, such as a sheet of thin metal, is placed on a table, on an openwork surface with protrusions, so that the sheet metal rests only on individual points of each protrusion. Such design of the table surface makes it possible to discharge material ejected on the opposite side of the impact of the laser beam, in order to prevent damage to the other surface of the cut sheet. A device with suction cups is used for loading. Suction cups pick up the sheet metal and transport it to the processing area. The second set of carriers in the form of combs lifts all cut out workpieces and the skeleton from the processing area and moves them further to the unloading area where the operator sorts and collects the workpieces. The solution does not allow cutting sheet metal delivered continuously without stopping, and the openwork surface becomes soiled by the ejected molten cut material, requiring a complicated and time-consuming cleaning process at a later stage.

A German invention description No. DE102004034256 discloses a system for laser cutting of thin materials. The system generally includes two belt feeders, arranged in such a way that there is a slot between the end of the first belt feeder and the end of the second belt feeder, allowing the removal of material released during laser cutting. Belt feeders are designed so that the aforementioned slot can move along the direction of transport of the web of material to be processed, and this movement is synchronized with the movement of the gate on which the laser cutting head is placed, so that the slot always falls under the laser beam from the cutting head. The gate with a laser cutting head provides movement in two perpendicular directions.

### SUMMARY

Technical problem to be solved: Existing equipment and methods of laser cutting of sheet metal do not constitute an integrated unified structure including elements of the unloading area, cutting area and the cut material collecting area, additionally ensuring separation of waste and workpieces, also in terms of size. Additional collecting equipment or tables are required to collect workpieces in known equipment. Conveyor tables with a comb load-bearing platform are prone to burning and deterioration due to high temperatures and contamination by dust and waste that occur during cutting. This results in the need for frequent replacement of load-bearing elements. Known cutting equipment and methods also do not provide separation and collection of workpieces and waste during the ongoing process without stopping the machine, including segregation of workpieces and waste into small and large. It is also not possible to automatically separate individual workpieces or waste and move them out of the cutting area while the cutting process is in progress. Sheet feeding and cutting often involve cases of sheet deviation from the trajectory along the X axis, slipping on the load-bearing elements of the conveyor, i.e. instability of the position of the sheet on the conveyor during movement.

The purpose of the invention is to develop a universal, integrated and fully automated, software-controlled device and method for continuous cutting of sheet metal, fed both from a coil and in the form of a sheet. The device and method are to provide a continuous and stable feeding and cutting process, and ensure separation and collection of workpieces and waste, with all operations of material feeding, movement, cutting, segregation and removal of workpieces, waste and skeleton after the cutting process to be carried out simultaneously, continuously, without stopping the machine. All guides and moving elements are to be connected to the body of the cutting machine, and the efficiency of the process is to be increased with the possibility of moving the sheet metal in both directions of the X axis. In addition, the device and method are to ensure the simultaneous possibility of segregating waste and workpieces into large and small ones, as well as the possibility of separating individual workpieces and waste without interrupting or suspending the material feeding process, optimal size of the cutting working area, cutting head operation in three directions, ability to use the appropriate maximum power of the laser source for the maximum sheet thickness. The cut openwork parts should be transported without mixing or hooking the elements to ensure smooth, undisturbed sorting. The solution should reduce human work in segregating and collecting workpieces and waste to a minimum, and ensure sheet metal cutting that minimizes the amount and size of waste.

A laser cutting machine for continuous cutting of sheet metal, especially unrolled from coils or fed automatically in sheets, according to the invention, is characterized by the fact that the loading conveyor, slidably mounted on the internal linear guides of the cutting machine body, is equipped with a rotating load-bearing element, rotating circumferentially in both directions in accordance with set software, and behind the loading conveyor, an internal conveyor is mounted on the same guides, equipped with a rotating load-bearing element that rotates circumferentially in both directions in accordance with the set software, while between the end of the loading conveyor and the beginning of the internal conveyor there is a slot constituting the cutting area, and at the ends of the conveyors creating the slot there are fixed supports with upper external edges, the distance between the external edges of the supports determines the width of the cutting slot, and the cutting head unit moves above the sheet in the slot area dynamically in the X, Y, Z axes, according to the set software, while at least one side gripper is slidably mounted on at least one side of the cutting machine body, moving linearly in both directions along the X direction and holding the edge of the sheet metal at any selected moment during the process from loading to the very end of cutting the sheet metal, in places necessary to ensure accuracy and stabilization of moving, positioning and cutting the sheet metal, and the internal conveyor is detachably connected to the unloading conveyor, which is a separate module connected directly to the internal conveyor and moving linearly in both directions along the X direction thanks to the linear drive of the internal conveyor, and containing a rotating load-bearing element of the unloading conveyor, while in the working area under the loading and internal conveyors there is an extraction unit consisting of left and right extraction collecting modules arranged symmetrically along the separator at the bottom of the cutting machine with rotating left and right load-bearing elements, from the air channel, from the pipe channels extracting gases and dust, with the cutting machine containing at least one module for collecting sorted workpieces and/or waste, which is the place where these workpieces and/or waste are discharged from the load-bearing elements of the cutting machine's linear conveyors operating along the X axis.

It is advantageous when the rotating load-bearing elements of the loading conveyor and the internal conveyor are brush belts.

It is advantageous when the loading and internal conveyors are linearly driven by magnetic linear motors mounted to the internal walls of the cutting machine body between the guides of the loading conveyor and internal conveyor, having handles with mounting plates on the side walls with carriages attached to them that cooperate with the body guides, which allows linear movement of the conveyors in both directions of the X direction.

It is advantageous when the upper surfaces of the fixed supports of the loading conveyor and the internal conveyor are equipped with rollers that reduce the friction of sheet metal travel.

It is advantageous when the cutting head unit mounted on the traverse moves linearly in the X direction along the cutting head guides and traverse guides mounted on the cutting machine body.

It is advantageous when the cutting head guides and traverse guides are mounted in the body above the guides of the loading and internal conveyors and above the gripper guides, and their drive is provided by magnetic motors of the cutting head and traverse located between the linear guides of the cutting head and the traverse guides.

It is advantageous when the grippers are mounted slidably along the entire length of the linear guides mounted in the body above the linear guides of the loading and internal conveyors, with blocks of a magnetic motor driving the grippers between the guides of the grippers.

It is advantageous when the gripper is a uniform structural unit containing, on the front side, jaws that hold the sheet metal on the edge, which are located in the gripper cover and closed or opened by an actuator, and, on the rear side, on the gripper mounting plate, two rows of carriages that cooperate with the gripper guides as they move, and a power cable clip.

It is advantageous when the grippers are mounted only on one side of the body.

It is advantageous when the cutting machine is equipped with three grippers.

It is advantageous if the rotating load-bearing element of the unloading conveyor has the form of a rotating belt rotating towards that rotates toward the outside of the machine, where the material is collected or discharged.

It is advantageous when the load-bearing elements of the left and right conveyor of the extraction unit are steel belts.

It is advantageous when the extraction air channel is divided by the inner bulkhead walls into air chambers having hinged outer walls on two sides, on the outside of the air chambers on two sides runs a pipe channel with inlet openings with flaps, located at heights corresponding to each air chamber, closed or opened using the actuator mechanism while extracting gases and dust from the selected chamber over which the cutting head is currently located, in accordance with the set software, with the outer bulkhead walls of the air channel determining the working range of cutting.

It is advantageous when the cutting machine contains three transverse collecting modules working along the Y axis, the first transverse module collecting small waste is located at the end of the left conveyor of the extraction unit, the second transverse module collecting small workpieces is located at the end of the right conveyor of the extraction unit, and the third transverse module collecting large workpieces, large waste and skeleton is located at the end of the unloading conveyor.

It is advantageous when the transverse modules for collecting workpieces and waste are belt conveyors on whose load-bearing elements the workpieces and waste fall, respectively, during the continuous process of cutting and separation of large and small workpieces, large and small waste, as well as the skeleton.

It is advantageous when the unloading conveyor has a screw shape, which results in a greater range of travel.

The method of continuous laser cutting of sheet metal in the laser cutting machine described above, unrolled from a coil or fed in sheets, is characterized by the fact that the sheet unrolled from the coil or the fed in sheets is placed on the rotating load-bearing element of the loading conveyor, where the sheet is gripped by its edge by the grippers and moved together with the conveyor and grippers along the X axis into the interior of the machine under the laser head, and at the same time the internal conveyor equipped with a rotating load-bearing element moves to the loading conveyor in such a way that between the end of the loading conveyor equipped with a fixed support and the beginning of the internal conveyor equipped with a fixed support, there is a technological slot along the Y axis of the conveyors, constituting a cutting area with the width, and when the outer edge of the sheet exceeds the slot area and is located on the load-bearing surface of the internal conveyor, the sheet is supported by two fixed supports of the loading conveyor and internal conveyor, and the laser head starts the cutting process, which takes place only in the area of the cutting slot and with the sheet metal supported on both sides by fixed supports, while the head with the laser source and traverse moves over the supported sheet metal in accordance with the set software in three directions X, Y, Z, and the width of the working range of cutting and head movement determines the position of the external bulkhead walls of the air channel of the extraction unit, with air chambers, located in the cutting machine space under the loading conveyor and internal conveyor, whereby in the first stage of cutting, small waste is cut out, and the sheet metal together with the grippers, the loading conveyor and internal conveyor moves along the machine over the left part of the extraction unit and the laser head b begins to cut out small waste, which falls on the left conveyor of the extraction unit and is transported outside the machine via the transverse collecting conveyor, in the second stage of cutting the sheet metal along with the grippers, the loading conveyor and internal conveyor moves along the machine over the second right part of the extraction unit and the laser head begins to cut out small workpieces, which fall on the right conveyor of the extraction unit and are transported outside the machine via the transverse collecting conveyor, then the large waste WL is cut out from the remaining part of the sheet metal, the head the laser continues to move over the slot, and the large waste after being cut out is located on the surface of the rotary load-bearing element of the internal conveyor and is transported further to the unloading conveyor integrated with the internal conveyor, which performs the same linear movements along the X axis as the internal conveyor, and then falls onto the transverse collecting conveyor of large waste and skeleton, followed by cutting out a large workpiece from the remaining part of the sheet metal, which, after being cut out, is located on the surface of the rotating load-bearing element of the internal conveyor and is further transported to the unloading conveyor integrated with the internal conveyor, and the next stage of cutting is the cutting of the skeleton from the rest of the sheet metal, where the skeleton, after being cut out, is on the surface of the rotating load-bearing element of the internal conveyor and is further transported to the unloading conveyor integrated with the internal conveyor with the load-bearing element, performing the same linear movements along the X axis as the internal conveyor, and further falls on the transverse collecting conveyor of large waste and skeleton, with all stages and operations occurring in the machine being automated and controlled by external software, i.e. sheet metal movement, laser cutting, loading conveyor movement and rotation, internal conveyor movement and rotation, workpiece separation, skeleton separation, waste separation occur at the same time, without the need to stop the machine.

It is advantageous when the rotational speed of the load-bearing element of the internal conveyor is increased temporarily in order to separate the cut-off large waste, large workpiece and skeleton from the remaining sheet metal.

It is advantageous when large workpieces are placed in the skeleton where the skeleton is cut into small pieces, and after the skeleton is cut from the large workpiece, the internal conveyor accelerates its belt rotation moving the large workpiece along with the skeleton away from the part of the sheet metal of the remaining large elements that have not been cut yet.

In the case of sheet metal unrolled from a coil, the cutting process can continue until there is no sheet in the coil.

It is possible to additionally load a ready sheet of metal onto the loading conveyor when no sheet metal unrolled from a coil is fed to the device. After cutting everything out of the sheet, the machine returns to the option of loading a new sheet. All parts of the machine return to the starting point.

When cutting large workpieces, thanks to the appropriately selected travel speeds of the loading and internal conveyors in the X axis and the rotational speed of their rotating load-bearing elements, the sheet can be stationary in relation to the cutting head.

With the method of cutting and sorting developed in this way, in the device constituting the subject of the invention, it is possible to cut any waste or openwork without the risk of the elements twisting, turning or overlapping, thus making sorting difficult. The cut openwork elements can be removed one by one from the machine, separated from the cut waste and other elements.

Finished workpieces can be collected from the collecting area automatically via the robotic arm or by the operator.

The loading and internal conveyors, together with the grippers, can transport and move sheet metal whether from coil or sheet in two directions of the X axis, which allows increasing the dynamics of processing in the X and Y axis and the efficiency of processing, which, due to the weight of the traverse and cutting head, is always the biggest challenge.

### BRIEF DESCRIPTION OF THE DRAWINGS

The object of the invention is shown in examples of execution in the drawing, where:

FIG. 1 shows a perspective general view of the cutting machine from the operator's side with the loading conveyor cover closed with the X, Y and Z axes schematically marked.

FIG. 2 shows a side view of the cutting machine built with covers forming a uniform body of the cutting machine from the operator's side with the loading, cutting and collecting areas of the skeleton and workpieces generally marked.

FIG. 3 depicts an aerial view of the device/cutting machine with tilted windows of the electrical cabinet and cut workpieces/skeleton on the collecting conveyor and loaded sheet metal on the loading conveyor work surface.

FIG. 4 depicts a perspective view of the cutting machine with schematically shown interior with conveyors, extraction system and cutting head.

FIG. 5 shows a view of the machine parts from the loading side with grippers and transverse collecting conveyors.

FIG. 6 shows a schematic layout of the basic modules of the cutting machine with grippers stabilizing the sheet fed from the coil and the cutting head in position above the cutting slot.

FIG. 7 shows a view of the cutting machine including the extraction unit with air extraction pipes and the internal mounting elements of the cutting head, conveyors and grippers along with the drive elements.

FIG. 8 shows a perspective view of the gripper from the top right with the jaws open.

FIG. 9 shows a perspective view of the gripper from the top right with the jaws closed.

FIG. 10 shows a perspective view of the gripper from the rear with the elements for attachment to the guide.

FIG. 11 shows the gripper unit in a rectangular view from the side left with the jaws open.

FIG. 12 shows the construction and mounting of the gripper in the machine with the jaws clamped on the sheet metal in a side view from the right.

FIG. 13 shows a view of the machine from the loading conveyor with the three grippers stabilizing the sheet metal.

FIG. 14 shows a view of the cutting machine with the loading conveyor and grippers in the material loading position and with the internal and collecting conveyor fully extended, where the first gripper is in its maximum position.

FIG. 15 shows a view of the cutting machine with grippers in position during machine operation with the internal and collecting conveyor retracted to the maximum-the external gripper holds the sheet on the internal conveyor.

FIG. 16 shows a view of the cutting machine with grippers in position during machine operation with the internal and collecting conveyor retracted to the maximum-the external gripper is at the end of the body with the collecting conveyor retracted.

FIG. 17 shows a schematic general view of the machine including the internal and unloading conveyors and the uncovered part of the extraction unit with air chambers.

FIG. 18 shows a workpiece view of the structure at the junction of the connection of the internal and unloading conveyors from FIG. 17.

FIG. 19 shows a workpiece view of the supports of the loading and internal conveyors placed in the cutting zone and the cutting head placed above the conveyors in the cutting slot.

FIG. 20 shows a perspective view of the extraction unit from above, FIG. 21 shows a schematic side view of a fragment of the cutting machine structure with the extraction unit and the loading and internal conveyors arranged above it, and the cutting head in position over the area between the conveyors.

FIG. 22 shows a schematic representation of the position of the cutting head and grippers during loading of sheet metal from the coil.

FIG. 23 shows a schematic representation of the position of the head and grippers during loading of sheet metal.

FIG. 24 shows a schematic representation of the position of the cutting head and grippers and the outer edge of the sheet metal located in the cutting zone resting on the supports of the loading and internal conveyors.

FIG. 25 moving the sheet metal into the laser cutting zone-shows a schematic representation of the position of the cutting head and grippers and the outer edge of the sheet located in the cutting zone resting on the supports of the loading and internal conveyors.

FIG. 26 shows the moved sheet metal into the cutting zone with the outer edge resting on the support of the internal conveyor, with the cutting head in opposition ready to cut over the cutting slot.

FIG. 27 shows the position of the conveyor head in the process of cutting out the small waste falling on the left conveyor of the extraction unit.

FIG. 28 shows the schematic positions of the head unit, the cutting slot during the process of cutting out the small waste as in FIG. 27.

FIG. 29 shows the position of the head and conveyors in the process of cutting out a small workpiece falling on the right conveyor of the extraction unit.

FIG. 30 shows the schematic positions of the head unit, the cutting gap during the process of cutting out a small workpiece as in FIG. 29.

FIG. 31 shows a view of the sheet with an outline of the small workpieces to be cut out during the cutting of the small workpiece.

FIG. 32 shows the position of the head and conveyors during the cutting of the large waste.

FIG. 33 shows the position of the head and conveyors during the cutting of the large waste during the separation with the unloading conveyor.

FIG. 34 shows a pictorial representation of the sheet metal with large cut out workpieces and waste during the cutting of the large workpiece along with the alignment of the sheet.

FIG. 35 shows the position of the head and conveyors in the process of cutting out a large workpiece during the separation of large waste, large workpieces and skeleton by means of the internal conveyor.

FIG. 36 shows a view of the sheet during the cutting out of waste from a large workpiece.

FIG. 37 shows a view of the sheet during the subsequent cutting out of a large workpiece and separated waste by the rotation the brush belt of the internal conveyor.

FIG. 38 shows a view of the sheet during the cutting out of a large workpiece and the separation of large workpieces and waste from the remaining sheet by the rotation of the internal conveyor.

FIG. 39 shows a schematic view of the cutting machine with small and large workpieces and waste on individual conveyors during the cutting process.

FIG. 40 shows a schematic view of the separation of large workpieces and skeleton during the cutting process at the next stage in relation to FIG. 39.

FIG. 41 shows a schematic representation of a view of the end of the unloading conveyor discharging large workpieces and skeleton onto a cross conveyor.

### DETAILED DESCRIPTION

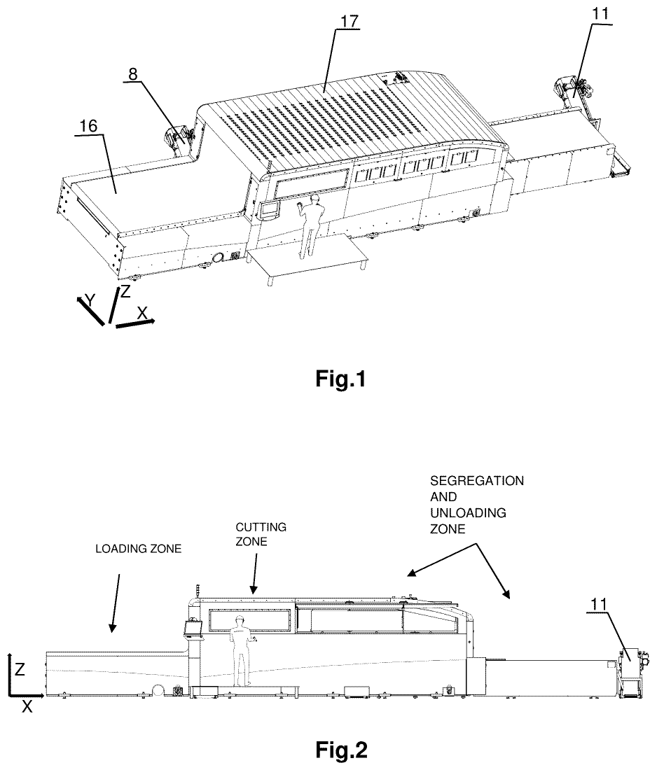

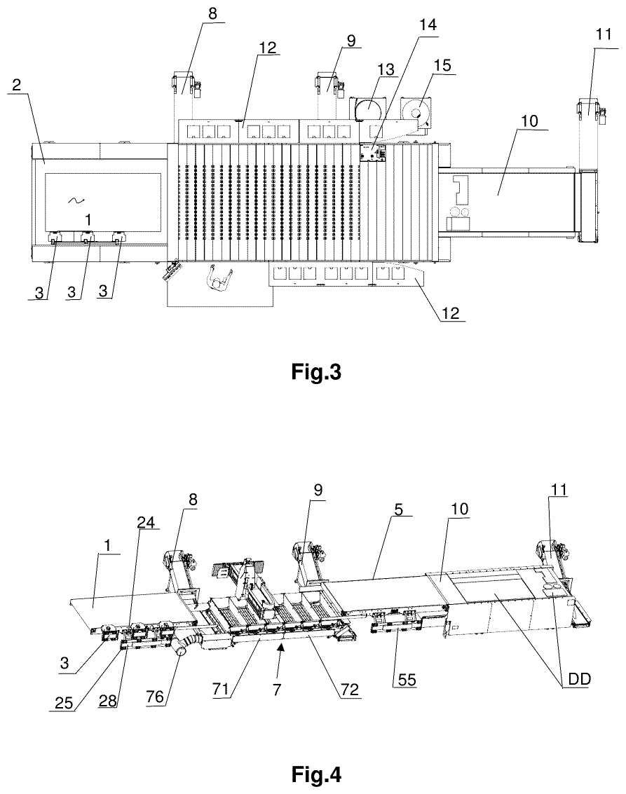

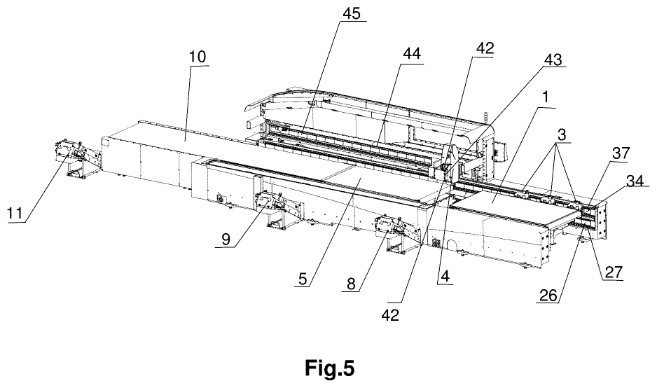

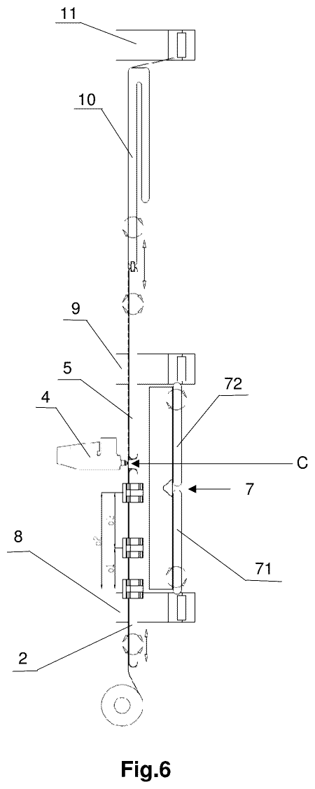

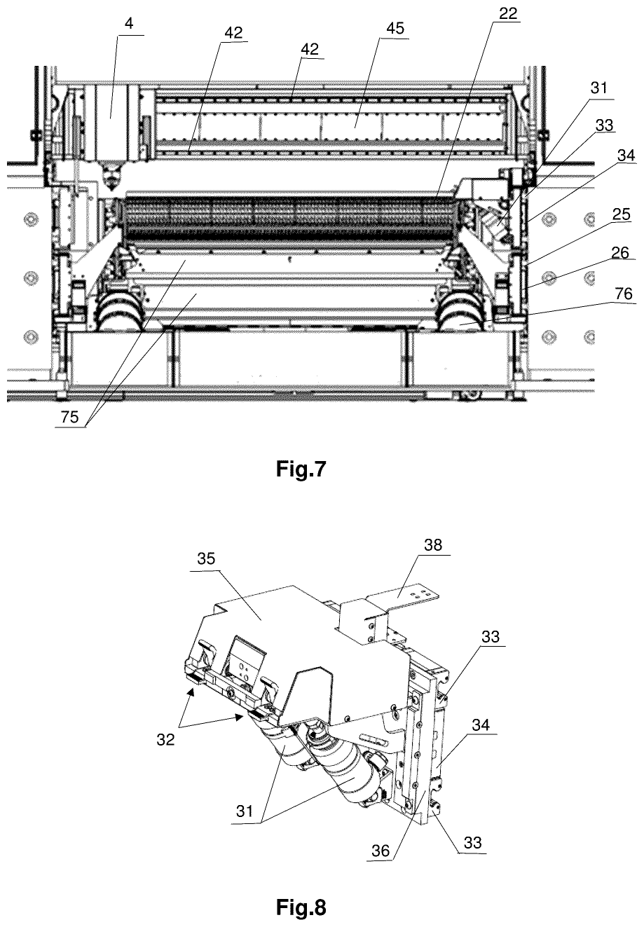

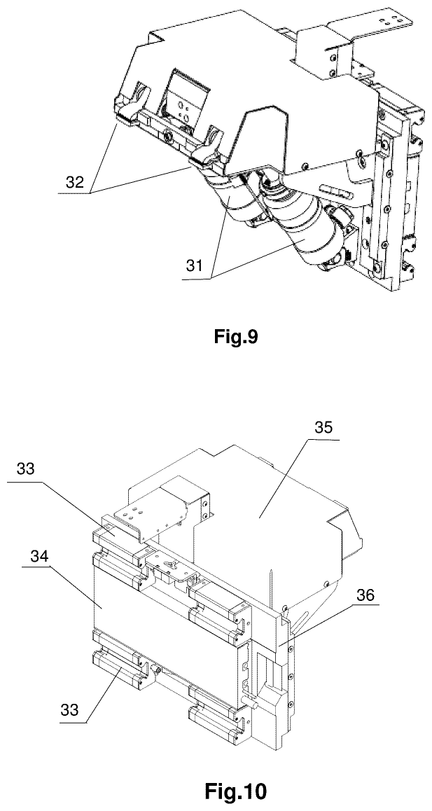

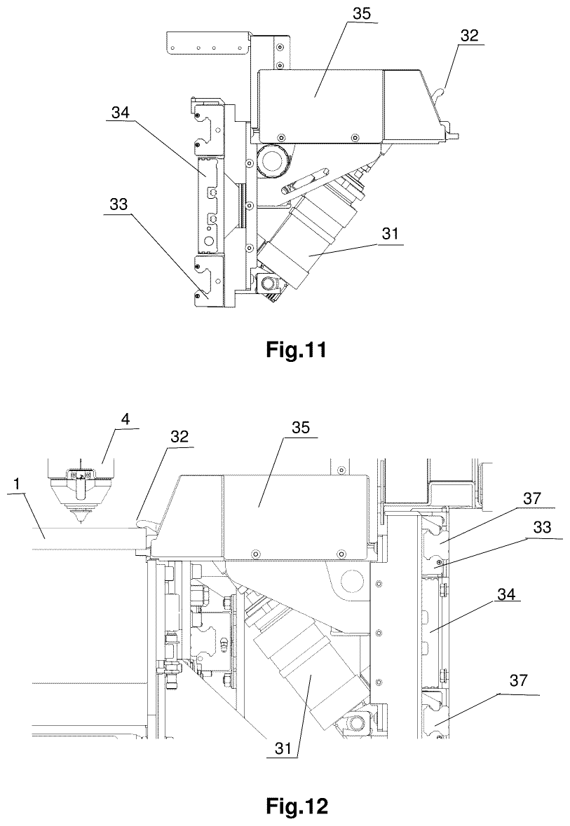

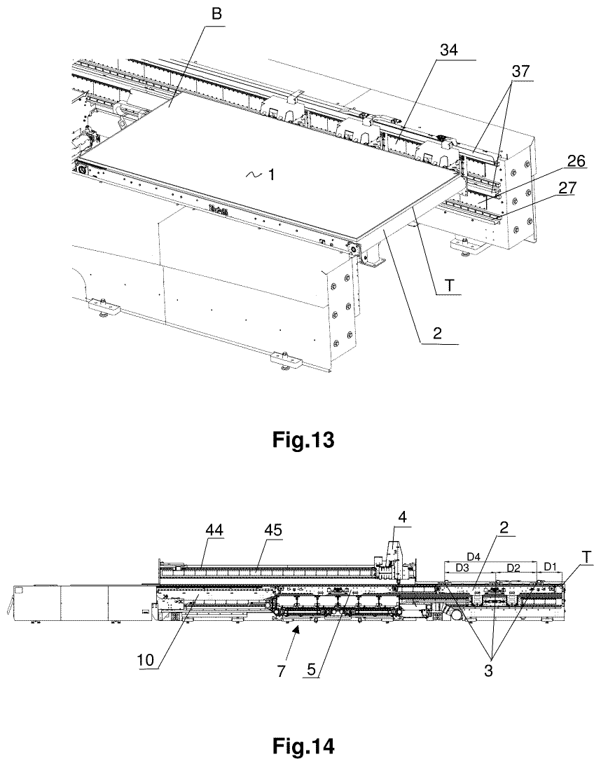

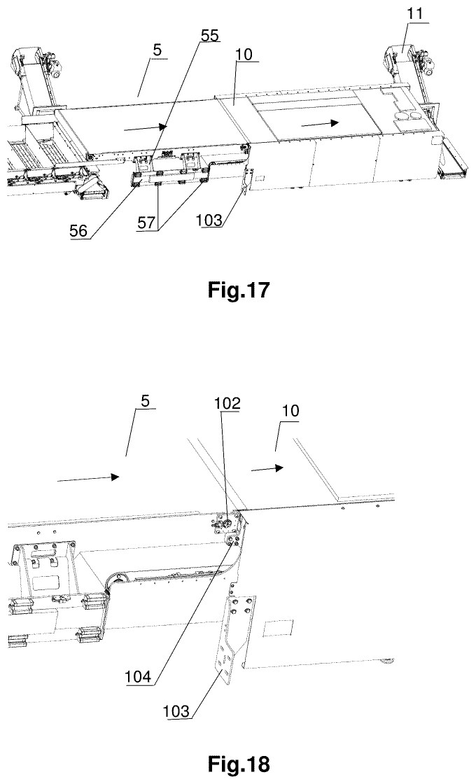

The cutting machine as a device is shown in the example of execution in FIG. 1-21.

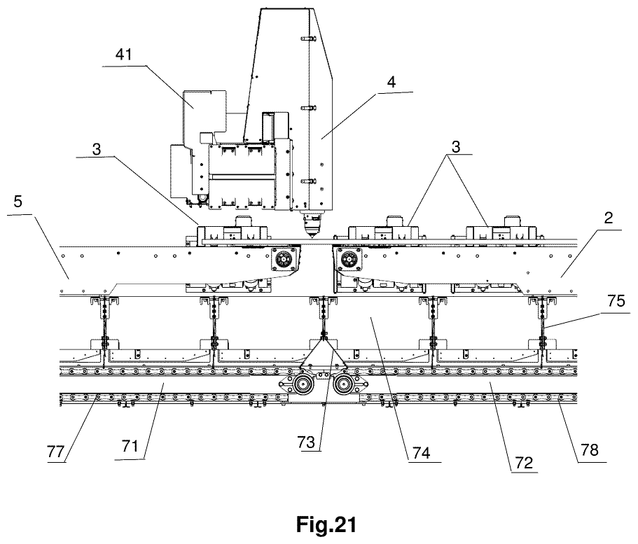

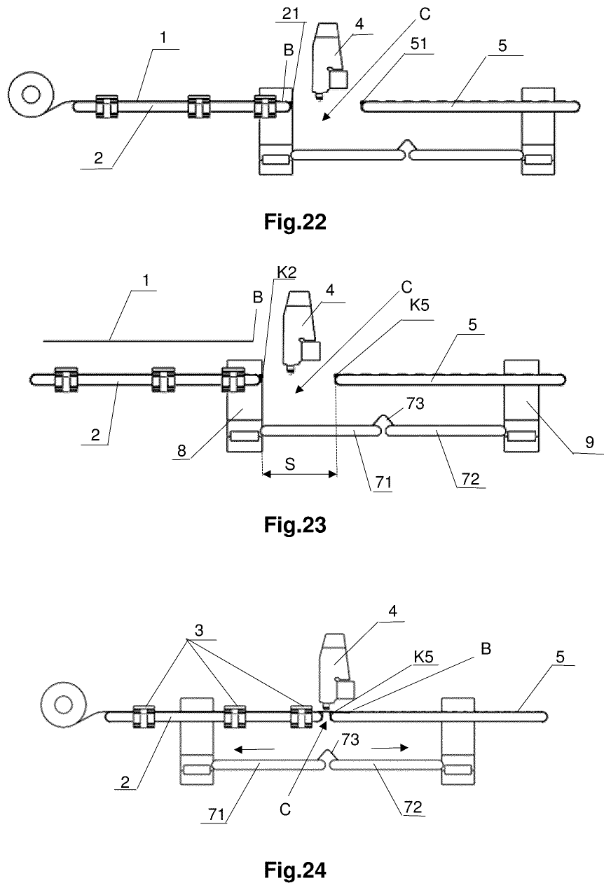

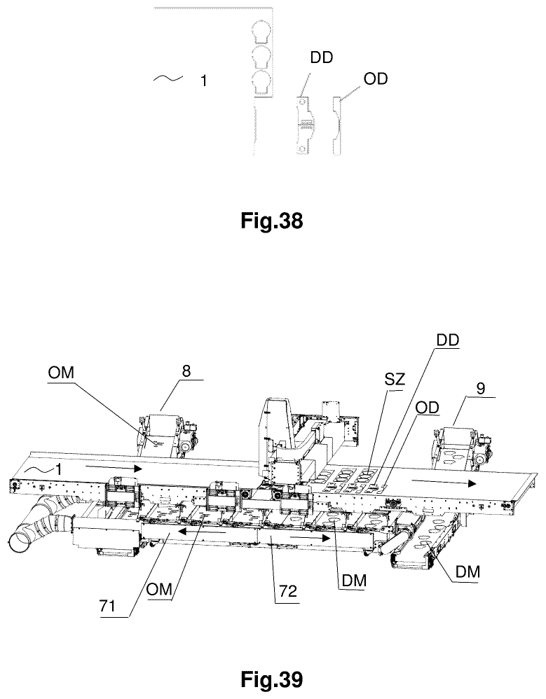

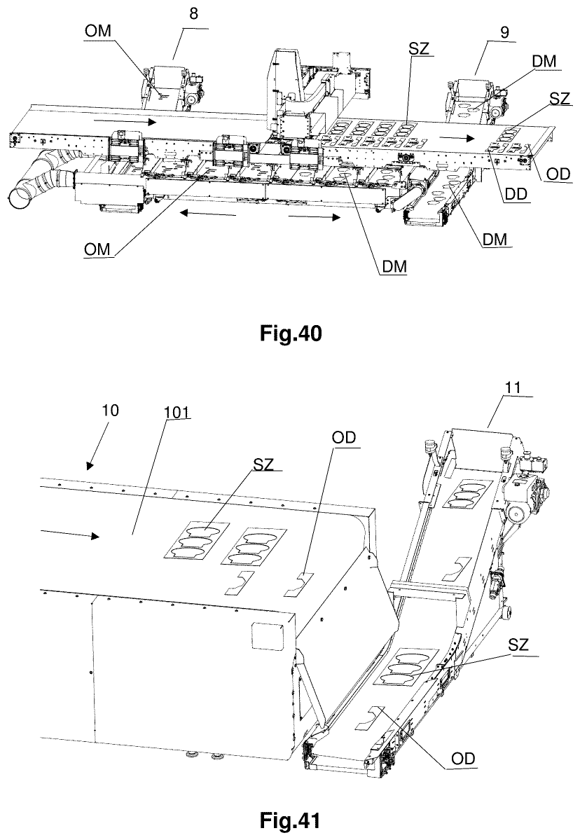

The method of cutting and segregating material in the cutting machine according to the invention is illustrated in FIG. 22-41.

A laser cutting machine for cutting sheet metal in which all processes are automated and controlled by external software includes two loading conveyors 2 moving linearly in the X direction and an internal conveyor 5 for transferring the processed material, with the loading conveyor 2 slidably mounted on internal linear guides 27 on both sides of the body, moving along these guides in both directions along the X direction, is equipped with a rotating load-bearing element 23 in the form of a brush belt, rotating clockwise or counterclockwise endlessly, according to the set software.

Behind the loading conveyor 2 there is an internal conveyor 5 mounted on the same linear conveyor guide 27, moving linearly in two directions along the X axis equipped with a rotating load-bearing element 53 in the form of a brush belt, rotating clockwise or counterclockwise endlessly, according to the set software.

The loading 2 and internal 5 conveyors are linearly driven by magnetic linear motors 26 mounted to the inner walls of the machine body between the guides 27 of the loading 2 and internal 5 conveyors. Both loading conveyor 2 and internal conveyor 5 have handles 24 and 55 with mounting plates 28 and 56 on the side walls with carriages 25 and 57 attached to them that cooperate with the body guides 27 which allows linear movement of the conveyors in both directions of the X direction. The drive of the axes 54 of the rotating load-bearing elements 23 and 53 of both conveyors 2 and 5 is implemented by means of servo drives or motors.

Between the end of the loading conveyor 2 and the beginning of the internal conveyor 5 is a slot C, which constitutes the cutting area. At the ends of the conveyors forming the slot C are fixed supports 21 and 51 with upper outer edges K2 and K5. The distance between the outer edges K2 and K5 of supports 21 and 51 determines the width S of the cutting slot C. The width S of the cutting slot C is adjusted automatically by the machine software depending on the size of the workpiece to be cut. The process of cutting sheet metal with the laser source occurs only in the cutting slot C outside the load-bearing elements 23 and 53 of the loading conveyor 2 and the internal conveyor 5 and outside the support surfaces. During the cutting and segregation process, the outer edge B of the sheet metal 1 is located on the surface of the load-bearing element 53 of the internal conveyor 5.

The head unit 4 mounted on the traverse 41, equipped with a control system moves linearly in the X-direction along the head guides 42 and the traverse guides 44 mounted in the body above the guides 27 of the conveyors and grippers 37, and is driven by the magnetic motors of the head 43 and the traverse 45 located between the linear guides of the head 42 and the linear guides of the traverse 44. The head 4 moves over the sheet metal dynamically in X, Y, Z axes.

During the process of cutting sheet metal, loading conveyor 2 and internal conveyor 5 can move independently of the fixed direction of sheet metal movement, constantly supporting it. The continuous support of the sheet metal and the movement of the slot C between the tables, which follows the movement of the laser head, is enabled by the accumulation of linear movements of the table and rotational movements of the load-bearing elements of the conveyors in the working range R of the machine at the same time. The accumulation of linear and rotational movements of the conveyors eliminates completely the friction between the sheet metal and the conveyor carrier, which follows the movement of the sheet metal as the entire conveyor moves. Supporting the sheet metal while cutting enables stable and precise cutting and material separation. The accumulation of linear and rotational movements also allows the sheet metal to remain stationary in relation to the head when cutting large workpieces DD.

The upper surfaces of the fixed supports 21 and 51 of the loading conveyor 2 and the internal conveyor 5, are equipped with rollers 22 and 52 that reduce the friction of sheet metal travel. Loading conveyor 2 and internal conveyor 5 can make independent linear movements relative to each other along the X axis by changing the distance with respect to each other-moving closer or further away from each other. Thanks to the independent movement of the loading conveyor and the internal conveyor in the X axis, the cutting machine provides an additional function of segregating finished workpieces and waste. Thanks to the additional movement of the sheet metal in the X axis, the cutting process is accelerated. Thanks to the additional rotation of the internal conveyor 5, it is possible to accelerate the separation of workpieces and to separate individual workpieces one by one.

Above the linear guides 27 of the internal conveyor and loading conveyor, at least on one side of the body, there are further linear guides 37 for three grippers 3 holding the edge of the sheet metal 1 at the appropriate moment in the process and in the places necessary to ensure accuracy and stabilization of moving, positioning and cutting the sheet metal. The grippers 3 move linearly along the entire length of their guides 37 and are driven by a magnetic motor 34, the blocks of which are located between the guides of the grippers 37. The grippers 3 move independently and without collisions in relation to each other and take positions in accordance with the set software. Depending on the stage of the process, the distances between the grippers and the distance of the gripper closest to the loading point from the first edge T of the contact between the sheet metal 1 and the load-bearing element 23 of the loading conveyor change. Each gripper 3 is a uniform structural unit containing, on the front side, jaws 32 holding the sheet metal on the edge, which are located in the cover 35 of the gripper 3 and closed or opened by an actuator 31, and, on the rear side, on the mounting plate 36 of the gripper 3, two rows of carriages 33 cooperating with the guides 37 of the grippers 3 as they move, and a power cable clip 38.

Electric cables running in a special plastic guide for electric cables are used to control the operation of the grippers. The guide has wires that follow the movable grippers 3 by bending or stretching.

The internal conveyor 5 is detachably connected via a spacer block 104 to the third unloading conveyor 10, which is a separate module in the form of a conveyor with a rotating load-bearing element 101 equipped with a mounting plate 103 from the bottom to the front of the cutting machine body.

The rotating load-bearing element 101 of the unloading conveyor 10 has the form of a rotating belt that rotates towards the outside of the machine where the material is collected or discharged, and the collecting conveyor 10 connected directly to the internal conveyor 5 moves linearly in both directions along the X direction thanks to the drive of the axis 102 of the internal conveyor 5 integrated with it. In the working area under the loading conveyor 2 and internal conveyor 5, there is an extraction unit 7 consisting of left conveyor 71 and right conveyor 72 arranged symmetrically along the separator 73 at the bottom of the machine with left 77 and right 78 load-bearing elements in the form of a steel belt for moving small waste to the left side of the conveyor and small workpieces to the right side of the conveyor, an air channel, pipe channels 76 for extracting gases and dust. The drive of the left conveyor 71 operates in a continuous mode to the left and the drive of the right conveyor 72 operates in a continuous mode to the right, throwing the material outside the extraction unit. The air channel is divided by inner bulkhead walls 75 into air chambers 74 having hinged outer walls 70 on two sides, on the outside of the air chambers 74 on two sides runs an air channel 76 with inlet openings with closing flaps, located at heights corresponding to each air chamber 74, with the flaps of a given inlet being opened by a mechanism 79 of an actuator during the extraction of gases and dust from the given chamber over which the cutting head 4 is currently located. The outer bulkhead walls 70 of the air channel determine the working range of cutting R. The cutting machine in the system contains three transverse collecting modules for collecting workpieces and waste, the first transverse module 8, collecting small waste OM, is located at the end of the left conveyor 71 of the extraction unit 7, the second transverse module 9 collecting small workpieces DM is located at the end of the right conveyor 72 of the extraction unit 7, and the third transverse module 11 collecting large workpieces DD, large waste OD and skeleton SZ is located at the end of the external conveyor 10. The transverse modules for collecting workpieces and waste are belt conveyors on whose load-bearing elements the workpieces and waste fall, respectively, during the continuous process of cutting. All moving elements and guides are mounted on a single body. The cutting machine's peripheral devices in the form of laser source 13, cooler 15 and a fan cabinet with filters, not shown in the drawings, to which a collective extraction pipe 7 is attached, cooperate with the machine in a known way. The body of the machine includes a roof panel 17, a louver that serves as a loading cover 16. It also includes a utility connection panel 14 and hinged electrical cabinet doors. The machine is also equipped with known control systems, automation components, drives, a laser generator cooling system, an automatic fume and dust removal system, and a laser beam transmission system.

The control elements connected to the components and elements of the cutting machine, as well as the PC input from which the process is programmed according to the set software, are located at the operator's station.

Thanks to this construction of the cutting machine, we can maintain a continuous cutting and sorting process and automatically discharge small workpieces DM, large workpieces DD, small waste OM, large waste OD and skeleton SZ without having to stop the machine.

An example of the process of cutting sheet metal and segregating workpieces and waste in the cutting machine described above is illustrated in FIG. 22-41.

The sheet metal 1 unrolled from coils or fed automatically in sheets 1 is placed on the loading conveyor 2 equipped with a rotating load-bearing element 23. The sheet metal 1 is loaded into the cutting machine automatically via feeders or feeding manipulators, which are known external devices of the machine.

The sheet metal 1 on the loading conveyor 2 is grabbed by the edge by three grippers 3 mounted in series on the same guides 37 inside the body on one side, with the first gripper located closest to the beginning of the loading conveyor and the third farthest. The distance between the first contact edge T of the sheet metal with the loading conveyor 2 and the first 3 gripper 3 is D1, the distance between the first and second gripper S is D1, between the second gripper S and the third 3 gripper S is D3, and the distance between the first gripper S and the third gripper S is D4. The edge of the first contact T of the sheet metal with the load-bearing element 23 of the loading conveyor 2 for the process in which the sheet metal is fed from the coil is the edge at which the outer edge B of the sheet metal 1 first contacts the surface of the load-bearing element 23 of the loading conveyor 2.

The contact edge T for sheet metal fed in sheets coincides with the edge of the sheet opposite the outer edge B, located at the time of loading and closest to the beginning of the loading conveyor 2.

The grippers move linearly along these guides along the entire X axis of the cutting machine. Holding the sheet metal by the edge by the grippers serves to accurately position the sheet metal throughout the cutting process and to support the movement of the sheet metal along the X axis. During the cutting process, some grippers 3 loosen the clamping jaws 32 and move along the edge of the sheet metal to a new position and then clamp their jaws on the edge of the sheet metal in the new position.

The two outermost grippers 3 always hold the sheet metal at the same time, while the middle gripper releases the sheet and moves toward the first gripper to grip the sheet in such a position as to ensure stepwise movement of the sheet metal towards the machine exit. After the sheet metal is clamped by the middle gripper, the first gripper loosens the jaws and moves the appropriate distance toward the load. After the first gripper has moved and clamped the jaws 32 in the new position, the third gripper loosens the jaws and moves to the appropriate place towards the second gripper. The process repeats cyclically in the same way, allowing the sheet metal travel in the following manner: grab, move, release between as you move, grab, move. General rule when moving the sheet: two gripper units always clamp the sheet and when two grippers hold the sheet, the third gripper releases the sheet and can change position

In the final cutting process, the sheet is held by only one gripper at the end of the sheet. However, during individual stages of the cutting process and separation of workpieces, waste and skeleton, the grippers move together with the sheet metal and may change the position of holding the sheet metal in relation to each other, or one of the grippers may stop holding the sheet metal as the sheet shortens. For sheet metal fed from a coil, all grippers hold the sheet metal and move in relation to each other.

FIGS. 22 and 24 schematically show the position of the grippers and head during the loading and cutting of sheet metal fed from a coil.

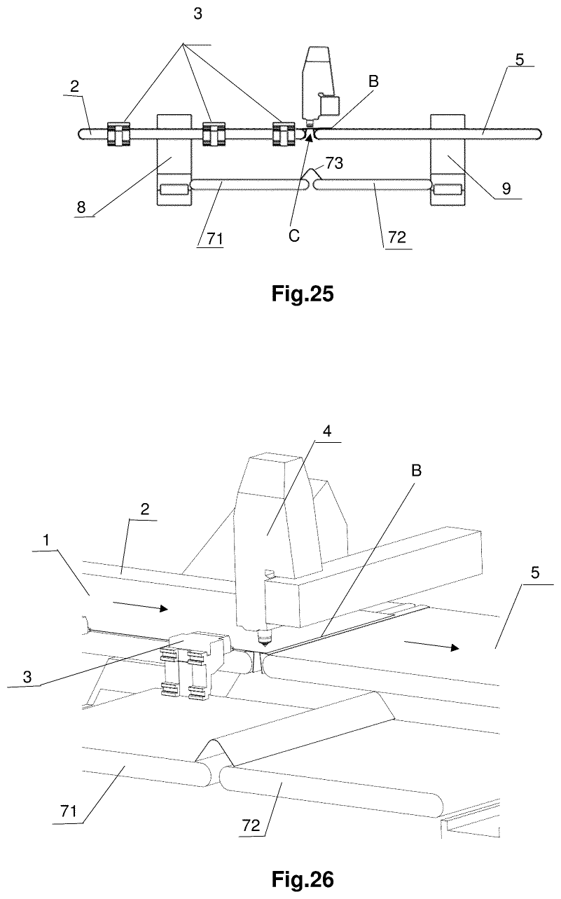

FIGS. 23 and 25 schematically show the position of the grippers and the head during sheet loading and sheet metal cutting.

The sheet metal 1 placed on the loading conveyor 2 and held by the grippers 3 moves with the conveyor and the grippers along the X axis into the interior of the machine under the laser cutting head 4, and at the same time the internal conveyor 5 used to collect the cut material and skeleton from the sheet metal and equipped with a rotating load-bearing element 53, moving along the machine along the X axis, moves to the loading conveyor 2 in such a way that along the Y axis of the conveyors, between the end of the loading conveyor 2 equipped with a fixed support 21 with the outer edge K2, and the beginning of the internal conveyor 5 equipped with a fixed support 51 with an outer edge K5, a technological slot C is set, constituting a cutting area with a width S. The conveyors can come very close to each other frontally, but do not touch each other during the entire cutting process.

FIG. 14-16 show exemplary positions of the loading conveyor 2, internal conveyor 5 and unloading conveyor 10, as well as the grippers 3 in various phases of the cutting process.

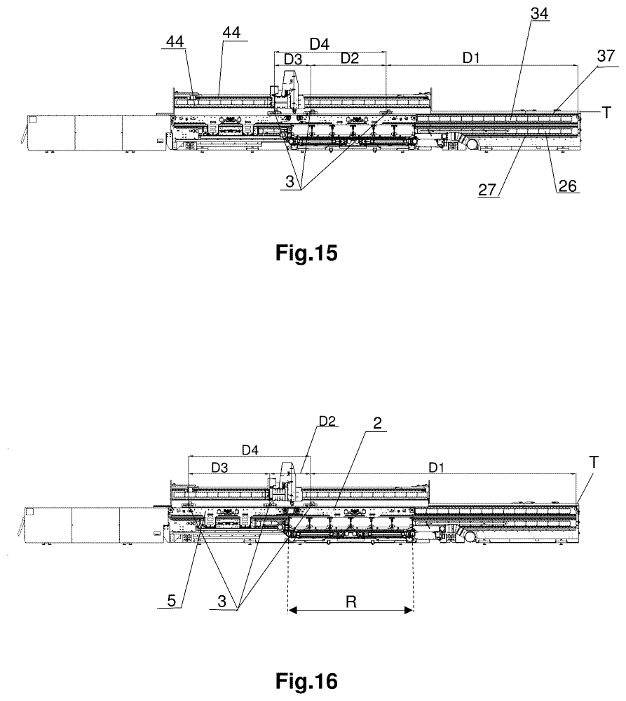

At the loading stage shown in FIG. 14, the first gripper 3 is located closest to the beginning of the internal conveyor at the minimum distance D1 from the contact edge T, and the internal conveyor 2 and unloading conveyor 10 are the most extended. During the operation of the cutting machine at the moment shown in FIG. 15, the gripper 3 first holds sheet 1 on the internal conveyor and its distance D1 from the edge T increases. During the operation of the cutting machine, at the moment shown in FIG. 16, with the external conveyor and collecting conveyor fully retracted, the third gripper is in the maximum position at the end of the body with the collecting conveyor 10 retracted. When the outer edge B of the sheet metal exceeds the slot area C and is located on the load-bearing surface 53 of the internal conveyor 5, it is supported on two fixed supports 21 and 22 of the loading conveyor 2 and the internal conveyor 5 and at this point the head starts the cutting process, which takes place only in the area of the slot cutting C and with the sheet metal supported on both sides by fixed supports, where the head with the laser source and traverse moves over the supported sheet 1 in accordance with the set software in three directions X, Y, Z, and the width of the cutting working range R determines the position of the external bulkhead walls 75 of the air channel of the extraction unit 7 with air chambers 74, located in the cutting machine space under the loading conveyor 2 and internal conveyor 5,

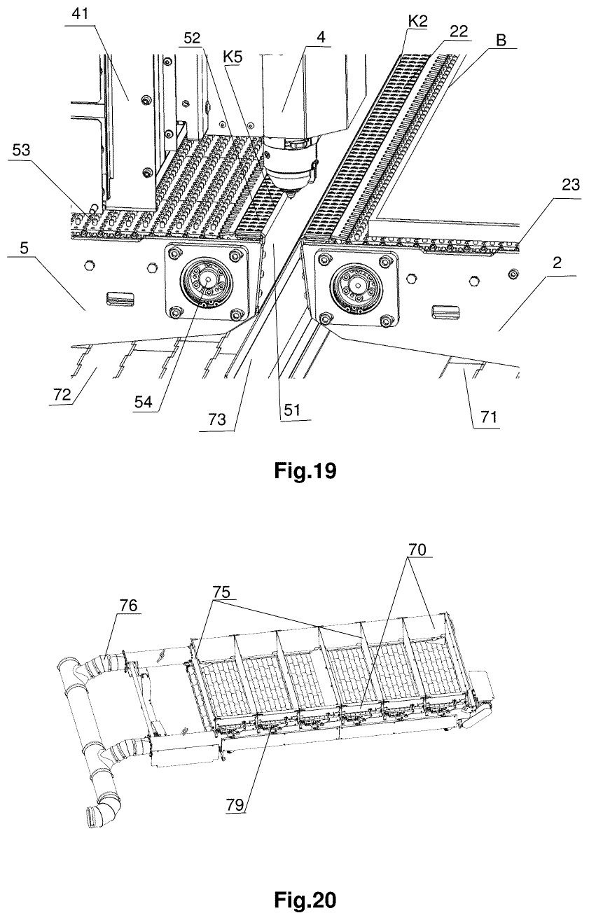

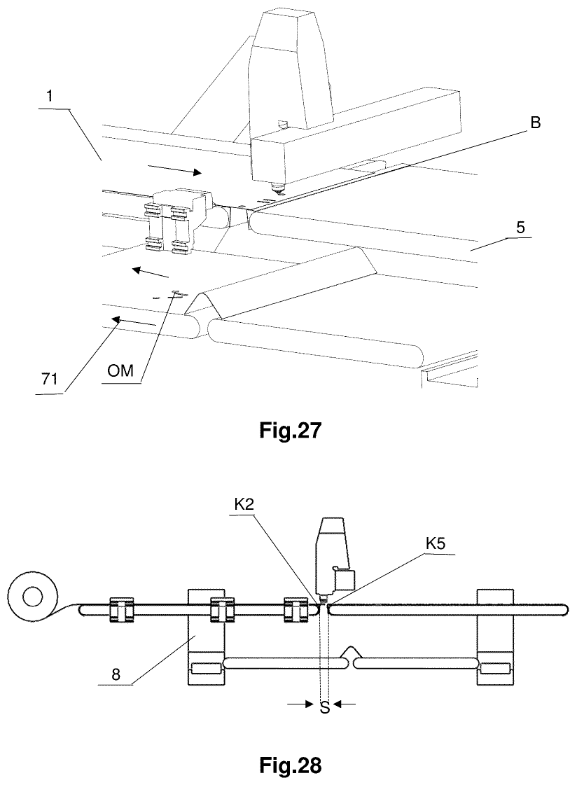

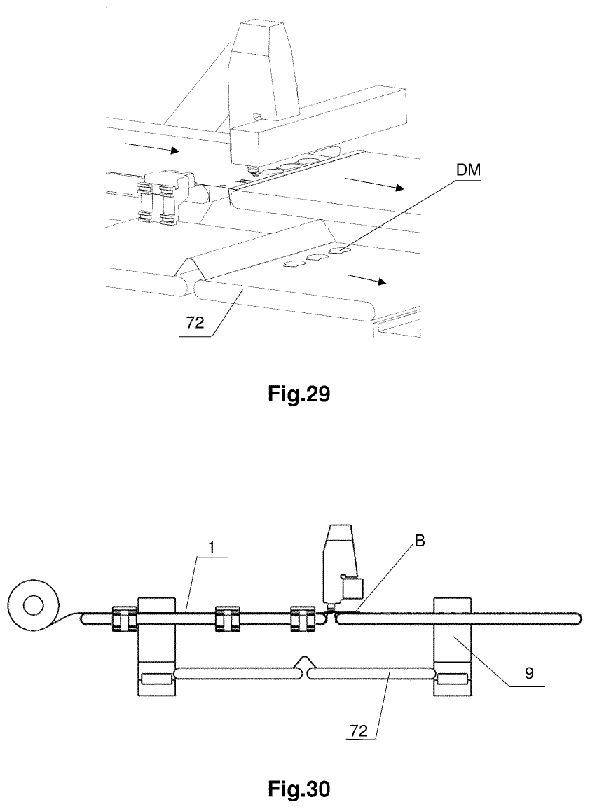

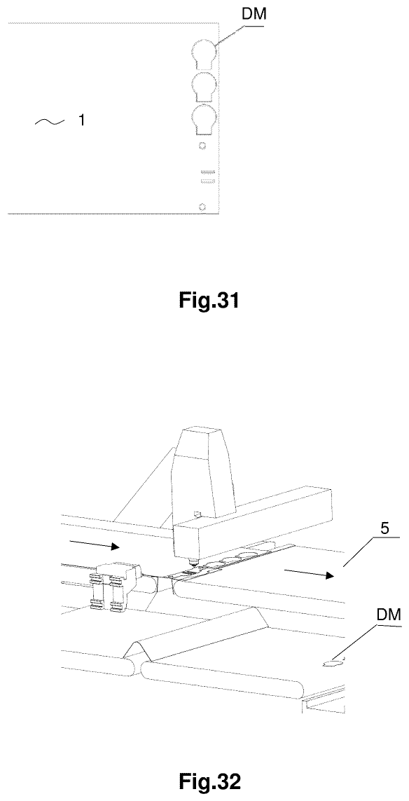

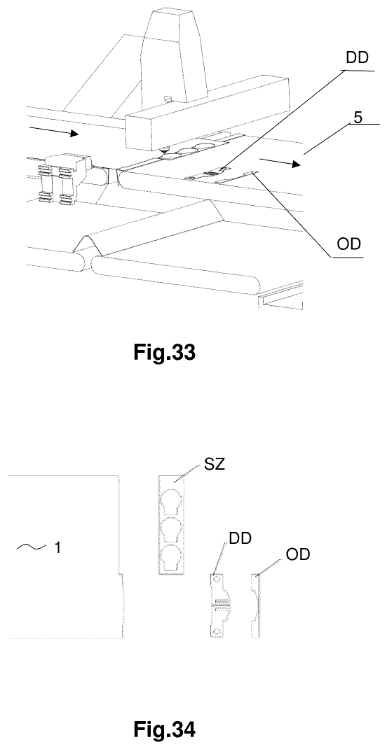

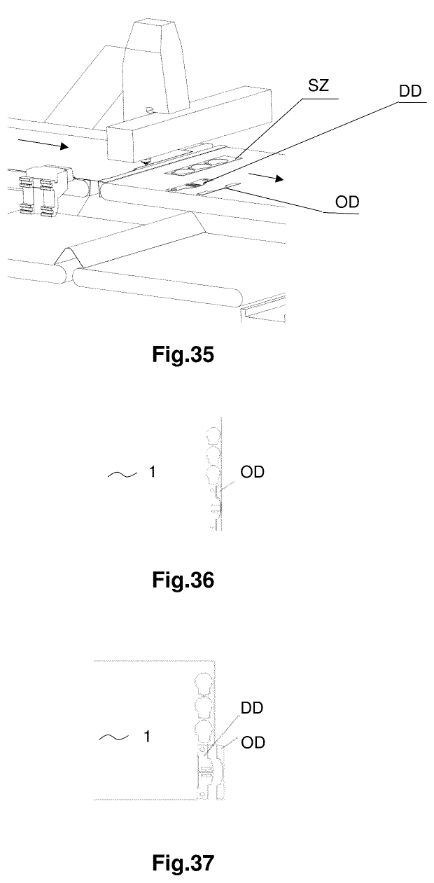

FIG. 19 and FIG. 21 show a detailed view of the cutting area and the position of the main elements during cutting, and FIG. 26 shows a schematic view. In the first stage of cutting, small waste OM is cut out, sheet metal 1 together with the grippers and the loading and internal conveyors moves along the machine over the first left part 71 of the extraction unit 7 and the head 4 starts cutting out small waste OM which falls onto the left conveyor 71 of the extraction unit 7 and are transported outside the machine via the transverse collecting conveyor 8 of small waste OM, FIG. 27 and FIG. 28 show a view and diagram of the position of the head 4 and the cutting slot C when cutting out small waste OM. In the second stage of cutting, sheet metal 1 together with the grippers and the loading and internal conveyors moves along the machine over the second right part 72 of the extraction unit 7 and the head 4 starts cutting out small workpieces DM, which fall onto the right conveyor 72 of the extraction unit 7 and are transported outside the machine via transverse collecting conveyor 9 of small workpieces DM, FIGS. 29 and 30 show a view and diagram of the position of the head 4 and the cutting slot C when cutting out small workpieces DM, and FIG. 31 shows a view of a sheet with small workpieces. The dimensions of DM and OM are selected in relation to the width S of the cutting slot C and the working dimensions of the load-bearing elements 77 and 78 of the left 71 and right 72 conveyor of the extraction unit 7, located under the air chambers 74 of the air channel, and the dimensions of the load-bearing elements of the transverse collecting conveyors of small workpieces 9 and waste 8 located at the ends of the left conveyor 71 and right conveyor 72. The next stage of cutting is to cut out the large waste OD, from the rest of sheet metal 1. After cutting, the large waste OD is located on the surface of the rotating load-bearing element 53 of the internal conveyor 5 and is transported further to the unloading conveyor 10 integrated with the internal conveyor 5, which performs the same linear movements along the X axis as the internal conveyor 5, and then falls onto the transverse collecting conveyor 11 of waste OD and skeleton SZ. In order to separate the cut-off large waste OD, the rotational speed of the load-bearing element 53 of the internal conveyor 5 is increased for a while. FIG. 32 and FIG. 33 show a view and diagram of the position of head 4 and cutting slot C during the cutting and separation of large waste OD. The next stage of cutting is cutting out a large workpiece DD from the remaining part of sheet metal 1, which, after cutting, is located on the surface of the rotating load-bearing element 53 of the internal conveyor 5 and is further transported to the unloading conveyor 10 integrated with the internal conveyor 5. Additionally, separation and movement of the workpiece from the sheet metal is achieved by temporarily increasing the rotational speed of the load-bearing element 53 of the internal conveyor 5. During the cutting of large workpieces DD, thanks to the appropriately selected travel speeds of the loading conveyor 2 and internal conveyor 5 in the X axis, as well as the rotational speed of their rotating load-bearing elements 23 and 53, the sheet metal 1 can be stationary in relation to the head. FIG. 34 shows a view of a sheet with large workpieces and waste during the cutting of large workpieces DD, FIGS. 35, 36, 37 and 38 show the location of the conveyors and the head during the separation process using internal conveyor 5. The next stage of cutting is to cut off the skeleton SZ from the rest of sheet metal 1. The skeleton, after being cut out, is placed on the surface of the rotating load-bearing element 53 of the internal conveyor 5 and is further transported to the 10 unloading conveyor with the load-bearing element 101 which is integrated with the internal conveyor 5, making the same linear movements along the X axis as the internal conveyor 5, and further falls onto the transverse collecting conveyor 11 of the waste and skeleton. In order to separate the cut-off skeleton, the rotational speed of the load-bearing element 53 of the internal conveyor is increased for a while.

It is advantageous when large workpieces DD are placed in the skeleton SZ where the skeleton is cut into small pieces, and after the skeleton SZ is cut from the large workpiece DD, the internal conveyor 5 accelerates its belt rotation moving the large workpiece DD along with the skeleton SZ away from the part of the sheet metal of the remaining large elements that have not been cut yet. In this way, large details DD and skeleton SZ are separated from the rest of the sheet metal.

FIGS. 39, 40 and 41 show the position of the various machine units during the segregation of large waste OD, large workpiece DD and skeleton SZ.

It is advantageous when the rotation of the internal conveyor 5 is accelerated, the remaining sheet metal is held by the side grippers 3, which does not cause uncontrolled movement of the sheet metal 1 during simultaneous laser cutting in a different position on the surface of the sheet metal. Finished workpieces are transported by another belt conveyor 10 to the workpiece collecting zone and the skeleton discharge zone to the skeleton SZ collecting conveyor 11.

Finished workpieces are collected from the collecting area automatically via the robotic arm.

It is possible to additionally load a ready sheet of metal 1 onto the loading conveyor when no sheet metal unrolled from a coil is fed to the device. After cutting everything out of the sheet, the machine returns to the option of loading a new sheet. All parts of the machine return to the starting point. In the case of sheet metal unrolled from a coil, the cutting process can continue uninterrupted until there is no sheet in the coil.

All stages and operations occurring in the machine are automated and controlled by external software, i.e. sheet metal movement, laser cutting, loading conveyor movement and rotation, internal conveyor movement and rotation, workpiece separation, skeleton separation, waste separation occur at the same time, without the need to stop the machine.

1. A laser cutting machine for continuous cutting of sheet metal, wherein the sheet metal is unrolled from coils or fed automatically in sheets, containing conveyors with load-bearing elements moving linearly in a direction of an X axis, with a slot between them, a head unit with a control system, a workpiece and waste collection module, equipped with elements of the control system enabling implementation of processes of cutting, feeding, loading and transfer of material for collection using set software, comprising: a loading conveyor which is slidably mounted on the internal linear guides of the a cutting machine body, which is equipped with a first rotating load-bearing element rotating circumferentially in both directions in accordance with the set software, and behind the loading conveyor there is an internal conveyor mounted on the internal linear guides, equipped with a second rotating load-bearing element rotating circumferentially in both directions in accordance with the set software, while between an end of the loading conveyor and the a beginning of the internal conveyor there is a slot (C) constituting a cutting area, and at ends of the loading conveyor and the internal conveyor forming the slot (C) there are fixed supports and with upper external edges (E2) and (E5), where a distance between the upper external edges (E2) and (E5) of fixed-supports determines a width(S) of the cutting slot (C), and the head unit moves above the sheet metal in the slot (C) dynamically in X, Y, Z axes, according to the set software, while at least one gripper is slidably mounted on at least one side of a body side of the laser cutting machine moving linearly in both directions along an X direction and holding an edge of the sheet metal, in places necessary to ensure accuracy and stabilization of moving, positioning and cutting the sheet metal, and the internal conveyor is detachably connected to the unloading conveyor, constituting a separate module directly connected to the internal conveyor and moving linearly in both directions along a working space under the loading conveyor and the internal conveyor there is an extraction unit consisting of left and right extraction collecting modules arranged symmetrically along a separator at a bottom of the laser cutting machine with rotating left and right load-bearing elements, from an air channel, from pipe channels extracting gases and dust, and the laser cutting machine contains at least one module for collecting segregated workpieces and/or waste, constituting the places where these workpieces are discharged and/or waste from the load-bearing elements of the laser cutting machine's linear conveyors operating along the X axis.

2. The laser cutting machine according to claim 1, wherein the first and second rotating load-bearing elements and of the loading conveyor and the internal conveyor are brush belts.

3. The laser cutting machine according to claim 1, wherein the loading conveyor and the internal conveyor are linearly driven by magnetic linear motors mounted to internal walls of the cutting machine body between the internal linear guides of the loading conveyor and internal conveyor, having handles and with mounting plates and on side walls with carriages and attached to them that cooperate with the internal linear guides, which allows linear movement of the conveyors in both sides of the X direction.

4. The laser cutting machine according to claim 1, wherein upper surfaces of the fixed supports and of the loading conveyor and the internal conveyor, are equipped with rollers and that reduce the friction of sheet metal travel.

5. The laser cutting machine according to claim 1, wherein the-a cutting head unit mounted on traverse moves linearly in the X direction along cutting head guides and traverse guides mounted on the cutting machine body.

6. The laser cutting machine according to claim 5, wherein cutting head guides and traverse guides are mounted in the body above the internal linear guides of the loading conveyor and the internal conveyors and above guides of the at least one gripper, and their drive is provided by magnetic motors of the cutting head and traverse located between the linear guides of the cutting head and the traverse guides.

7. The laser cutting machine according to claim 1, wherein the at least one grippers is mounted slidably along an entire length of the linear guides mounted in the body of the cutting machine above the internal linear guides of the loading conveyor and the internal conveyors, with blocks of a magnetic motor driving the at least one gripper between the guides of the at least one gripper.

8. The laser cutting machine according to claim 1, wherein the at least one gripper is a uniform structural unit containing, on a front side, jaws that hold the sheet metal on the edge, which are located in a cover of the at least one gripper and closed or opened by an actuator, and, on a rear side, on a mounting plate of the at least one gripper, two rows of carriages that cooperate with the guides of the at least one gripper as they move, and a power cable clip.

9. The laser cutting machine according to claim 1, wherein the at least one gripper is mounted only on one side of the cutting machine body.

10. The laser cutting machine according to claim 1, wherein the laser cutting machine is equipped with three grippers.

11. The laser cutting machine according to claim 1, wherein a third rotating load-bearing element of the unloading conveyor has the form of a rotating belt that rotates towards an outside of the machine where the material is collected or discharged.

12. The laser cutting machine according to claim 1, wherein the load-bearing elements and of the left and right extraction collecting modules of the extraction unit are steel belts.

13. The laser cutting machine according to claim 1, wherein the extraction unit is divided by inner bulkhead walls into air chambers having hinged outer walls on two sides, on an outside of the air chambers on two sides runs a pipe channel with inlet openings with flaps, located at heights corresponding to each air chamber, closed or opened using the an actuator mechanism while extracting gases and dust from a selected chamber over which the cutting head is currently located, in accordance with the set software, with the outer bulkhead walls of the air channel determining a working range of cutting (R).

14. The laser cutting machine according to claim 1, further comprising three transverse collecting modules working along the Y axis, wherein a first transverse module collecting small waste OM is located at the end of the left conveyor of the extraction unit, wherein a second transverse module collecting small workpieces DM is located at the end of the right extraction collecting module of the extraction unit, and wherein a third transverse module collecting large workpieces DD, large waste OD and a skeleton SZ is located at the end of the unloading conveyor.

15. The laser cutting machine according to claim 14, wherein the three transverse modules for collecting workpieces and waste are belt conveyors on whose load-bearing elements the workpieces and waste fall, respectively, during the continuous process of cutting and separation of large and small workpieces DD and DM, large and small waste OD and OM, as well as the skeleton SZ.

16. The laser cutting machine according to claim 1, wherein the unloading conveyor has a screw shape, which results in a greater range of travel.

17. A method of continuous laser cutting of sheet metal in a laser cutting machine, either unrolled from a coil or fed in sheets, including a stage of loading the sheet metal, a stage of moving the sheet metal to a cutting area, a stage of cutting the sheet metal with a laser head, a stage of collecting and/or discharging the cut workpieces and waste, with the laser head cutting being carried out outside the-load-bearing surfaces of conveyors, wherein the sheet metal unrolled from a coil or fed in sheets is placed on a rotating load-bearing element a loading conveyor, where the sheet metal is gripped by its edge by at least one gripper and moves with the conveyor and the at least one gripper along an X axis to an inside of the machine under the laser head, and at concurrently an internal conveyor equipped with a rotating load-bearing element, moves against the loading conveyor, in such a way that between an end of the loading conveyor equipped with a first fixed support and a beginning of the internal conveyor equipped with a second fixed support, there is a technological slot (C) along a Y axis of the conveyors, constituting a cutting area with a width(S), while when the outer edge (B) of the sheet metal exceeds an area of the technological slot (C) and is on the load-bearing surface of the internal conveyor, the sheet metal supports itself against the first and second fixed supports and of the loading conveyor and internal conveyor, and the laser head starts a cutting process, taking place exclusively in the cutting slot area (C) and with the sheet metal supported by the first and second fixed supports and on both sides, with the head with laser source and traverse moving over the supported sheet according to software in three directions X, Y, Z and a width of a working range (R) of cutting and movement of the laser head is determined by the a position of outer bulkhead walls of an air channel of an extraction unit, with air chambers, located in a space of the laser cutting machine under the loading conveyor and the internal conveyor, whereby in a first stage of cutting, small waste OM is cut out, and the sheet metal together with the at least one gripper, the loading conveyor and the internal conveyor moves along the machine over a left part of the extraction unit and the laser head begins to cut out small waste OM, which falls onto a left conveyor of the extraction unit and is transported outside the machine via a transverse collecting conveyor, in a second stage of cutting, the sheet metal, together with the at least one gripper, the loading conveyor and the internal conveyor, moves along the machine over a right part of the extraction unit and the laser head begins to cut out small workpieces DM, which fall onto a right conveyor of the extraction unit and are transported outside the machine via the a transverse collecting conveyor, then large waste OD is cut out from a remaining part of the sheet metal, the laser head continues to move over the technological slot (C), and the large waste OD, after being cut off, is located on the surface of the rotating load-bearing element of the internal conveyor, and is further transported to an unloading conveyor integrated with the internal conveyor, which performs identical linear movements along the X axis as the internal conveyor, and further falls on a transverse collecting conveyor of the large waste OD and a skeleton SZ, followed by cutting out a large detail DD from the remaining part of the sheet metal, which, after being cut out, is located on a surface of the rotating load-bearing element of the internal conveyor, and is further transported to the unloading conveyor integrated with the internal conveyor, and in a next cutting stage, the skeleton SZ is cut off from the remaining part of the sheet metal, where the skeleton SZ, after being cut off, is located on the surface of the rotating load-bearing element of the internal conveyor and is further transported to the unloading conveyor integrated with the internal conveyor with a supporting element that performs the identical linear movements along the X axis as the internal conveyor, and then falls onto the transverse collecting conveyor of large waste OD and skeleton SZ, with all stages and operations occurring in the machine being automated and controlled by external software occur simultaneously, without a need to stop the machine.

18. The method according to claim 17, wherein, in order to separate cut-off large waste OD, large workpiece DD and skeleton SK from the remaining part of the sheet metal, rotational speed of the load-bearing element of the internal conveyor is increased temporarily.

19. The method according to claim 17, wherein the large workpieces DD are placed in the skeleton SZ where the skeleton SZ is cut into small pieces, and after the skeleton SZ is cut from the large workpiece DD, the internal conveyor 5 accelerates its belt rotation moving the large workpiece DD along with the skeleton SZ away from a part of the sheet metal of the remaining large elements that have not been cut yet.

20. The method according to claim 17, wherein the stages and operations are sheet metal movement, laser cutting, loading conveyor movement and rotation, internal conveyor movement and rotation, workpiece separation, skeleton separation, and waste separation.
